(19) United States
(12) Patent Application Publication
(10) Pub. No.: US 2015/0166862 A1
(43) Pub. Date: Jun. 18, 2015

(54) COMPOSITION FOR POLISHING ALLOY MATERIAL AND METHOD FOR PRODUCING ALLOY MATERIAL USING SAME

(71) Applicant: FUJIMI INCORPORATED, Kiyosu-shi, Aichi (JP)

(72) Inventors: Hitoshi Morinaga, Kiyosu-shi (JP); Kazusei Tamai, Kiyosu-shi (JP); Maiko Asai, Kiyosu-shi (JP)

(73) Assignee: FUJIMI INCORPORATED, Kiyosu-shi, Aichi (JP)

(21) Appl. No.: 14/414,639

(22) PCT Filed: Jul. 16, 2013
(86) PCT No.: PCT/JP2013/069273

§ 371 Date: Jan. 13, 2015

(30) Foreign Application Priority Data
Jul. 17, 2012 (JP) 2012-159057

(51) Int. Cl. C09K 3/14

(52) U.S. Cl. CPC C09K 3/1436

(57) ABSTRACT

Provided is a metal alloy material polishing composition used for polishing a metal alloy material. The metal alloy material contains a first metal species as a main component and a second metal species that is of a different kind from the first metal species and has a standard electrode potential higher than that of the first metal species. The metal alloy material polishing composition contains a compound having a functional group bonded to carbon and capable of trapping the second metal species.

### TECHNICAL FIELD

The present invention relates to a metal alloy material polishing composition and a method for producing a metal alloy material using the same.

### BACKGROUND ART

Metal alloy materials have been used in various applications since they have mechanical strength, chemical resistance, corrosion resistance, and heat resistance superior to those of pure metal materials. Metal alloy materials are subjected to processing such as polishing (see Patent Documents 1 and 2).

### PRIOR ART DOCUMENTS

### Patent Documents

Patent Document 1: Japanese Laid-Open Patent Publication No. 01-246068

Patent Document 2: Japanese Laid-Open Patent Publication No. 11-010492

### SUMMARY OF THE INVENTION

### Problems that are to be Solved by the Invention

The objectives of the present invention are to provide a metal alloy material polishing composition that is capable of suppressing surface roughening and defects on a polished surface of a metal alloy material and to provide a method for producing a metal alloy material using the same.

### Means for Solving the Problem

In order to achieve the objectives described above and in accordance with the first aspect of the present invention, provided is a metal alloy material polishing composition used for polishing a metal alloy material, wherein the metal alloy material contains a first metal species as a main component and a second metal species that is of a different kind from the first metal species, the second metal species having a standard electrode potential higher than that of the first metal species, and wherein the metal alloy material polishing composition contains a compound having a functional group bonded to carbon and capable of trapping the second metal species.

The metal alloy material polishing composition may further contain abrasive grains, and in this case, the above-described compound is preferably immobilized on the abrasive grains.

Preferably, the main component of the metal alloy material is any one of magnesium, aluminum, titanium, chromium, and iron.

Preferably, the main component of the metal alloy material is aluminum. Preferably, the metal alloy material contains at least one metal element selected from the group consisting of iron, copper, and zinc in an amount of 1.0% by mass or more.

In accordance with the second aspect of the present invention, a method for producing a metal alloy material is provided that includes polishing a metal alloy material using the metal alloy material polishing composition according to the first aspect.

### Effect of the Invention

The present invention succeeds in suppressing surface roughening and defects on a polished surface of a metal alloy material.

### MODES FOR CARRYING OUT THE INVENTION

One embodiment of the present invention will now be described.

A metal alloy material polishing composition according to the present embodiment is used for polishing a metal alloy material. The metal alloy material contains a first metal species as a main component and a second metal species that is of a different kind from the first metal species. The second metal species has a standard electrode potential higher than the standard electrode potential of the first metal species.

Examples of the metal alloy material include aluminum alloys, titanium alloys, stainless steels, nickel alloys, and copper alloys.

The aluminum alloy is mainly composed of aluminum and further contains, for example, at least one selected from silicon, iron, copper, manganese, magnesium, zinc, and chromium. The content of the metal(s) other than aluminum in the aluminum alloy is 0.1 to 10% by mass, for example. Examples of the aluminum alloy include those of the alloy Nos. 2,000s, 3,000s, 4,000s, 5,000s, 6,000s, 7,000s, and 8,000s as described in the Japanese Industrial Standards (JIS) H4000:2006.

The titanium alloy is mainly composed of titanium and further contains, for example, aluminum, iron, and vanadium.

The content of the metal(s) other than titanium in the titanium alloy is 3.5 to 30% by mass, for example. Examples of the titanium alloy include those of the types 11 to 23, the type 50, the type 60, the type 61, and the type 80 as described in JIS H4600:2012.

The stainless steel is mainly composed of iron and further contains, for example, at least one selected from chromium, nickel, molybdenum, and manganese. The content of the metal(s) other than iron in the stainless steel is 10 to 50% by mass, for example. Examples of the stainless steel include SUS201, SUS303, SUS303Se, SUS304, SUS304L, SUS304NI, SUS305, SUS305JI, SUS309S, SUS310S, SUS316, SUS316L, SUS321, SUS347, SUS384, SUSXM7, SUS303F, SUS303C, SUS430, SUS430F, SUS434, SUS410, SUS416, SUS420J1, SUS420J2, SUS420F, SUS420C, and SUS631J1 as described in JIS G4303:2005.

The nickel alloy is mainly composed of nickel and further contains, for example, at least one selected from iron, chromium, molybdenum, and cobalt. The content of the metal(s) other than nickel in the nickel alloy is 20 to 75% by mass, for example. Examples of the nickel alloy include those of the alloy Nos. NCF600, NCF601, NCF625, NCF750, NCF800, NCF800H, NCF825, NW0276, NW4400, NW6002, and NW6022 as described in JIS H4551:2000.

The copper alloy is mainly composed of copper and further contains, for example, at least one selected from iron, lead, zinc, and tin. The content of the metal(s) other than copper in the copper alloy is 3 to 50% by mass, for example.

Examples of the copper alloys include those of the alloy Nos. C2100, C2200, C2300, C2400, C2600, C2680, C2720, C2801, C3560, C3561, C3710, C3713, C4250, C4430, C4621, C4640, C6140, C6161, C6280, C6301, C7060, C7150, C1401, C2051, C6711, and C6712 as described in JIS H3100:2006.

Preferably, the metal alloy material is mainly composed of any one of magnesium, aluminum, titanium, chromium, and iron, and more preferably aluminum. When the metal alloy material is mainly composed of aluminum, the metal alloy material preferably contains at least one metal element selected from iron, copper, and zinc in an amount of 1.0% or more by mass.

The metal alloy material polishing composition contains a compound having a functional group bonded to carbon and capable of trapping the second metal species, i.e., the metal that is other than the main component in the metal alloy material and has a standard electrode potential higher than that of the main component metal. This compound is used for the purpose of suppressing surface roughening and defects on a polished surface of the metal alloy material. When the metal alloy material contains two or more kinds of second metal species, it is preferred that the functional group of the compound be capable of trapping at least the metal species having the highest standard electrode potential, among the two or more second metal species.

The standard electrode potential is represented by the following equation when all chemical species participating in an oxidation reaction are in a normal state:

E0=−ΔG0/nF=(RT/nF)ln K

wherein E0 is a standard electrode potential, ΔG0 is standard Gibbs energy change of the oxidation reaction, K is an equilibrium constant thereof, F is a Faraday constant, T is an absolute temperature, and n is the number of electrons participating in the oxidation reaction. Thus, since the standard electrode potential varies depending on a temperature, a standard electrode potential at 25° C. is employed herein. The standard electrode potentials for aqueous solution systems are described in, for example, Handbook of Chemistry (fundamental part) II, revised 4th edition, pp. 464-468 (edited by the Chemical Society of Japan).

The functional group of the above-described compound is preferably an anionic group, and more preferably a group having ability of trapping the second metal species higher than that of a hydroxy group, and also, exhibiting a stable state where the second metal species is trapped. More specifically, the functional group is preferably a sulfo group or two or more carboxyl groups. That is, the compound in the metal alloy material polishing composition is preferably a compound having a sulfo group bonded to carbon or a compound having two or more carboxyl groups bonded to carbon.

The above-described compound may have one kind of a functional group only or two or more kinds of functional groups. The compound having a functional group bonded to carbon and capable of trapping the second metal species may be used singly or in combination of two or more kinds.

Examples of the above-described compound in the metal alloy material polishing composition include alkali metal salts, such as sodium salts and potassium salts, and ammonium salts.

Other examples of the compound in the metal alloy material polishing composition include polystyrenesulfonic acid and salts thereof, polyacrylic acid and salts thereof, iminodiacetic acid and salts thereof, and citric acid and salts thereof.

Preferably, the polystyrenesulfonic acid and salts thereof are soluble in water. The solubility of the polystyrenesulfonic acid and salts thereof is preferably 20 [g/100 g-H₂O] or more at 20° C., for example. The weight average molecular weight of the polystyrenesulfonic acid and salts thereof is preferably from 5,000 to 1,200,000, for example. The polystyrenesulfonic acid and salts thereof may be those having an introduced hydrophilic group, such as a hydroxy group or a carboxyl group, or those formed by copolymerization of styrenesulfonic acid or a salt thereof and a vinyl monomer other than styrenesulfonic acid and salt thereof.

Preferably, the polyacrylic acid and salts thereof are soluble in water. The solubility of the polyacrylic acid and salts thereof is preferably 40 [g/100 g-H₂O] or more at 20° C., for example. The weight average molecular weight of the polyacrylic acid and salts thereof is preferably from 2,000 to 200,000, for example. The polyacrylic acid and salts thereof may be those having an introduced hydrophilic group, such as a hydroxy group or a sulfo group, or those formed by copolymerization of polyacrylic acid or a salt thereof and a vinyl monomer other than polyacrylic acid and salt thereof.

In order to further suppress the surface roughening and the defects on a polished surface of the metal alloy material, it is preferred that the above-described compound in the metal alloy material polishing composition be at least one selected from polystyrenesulfonic acid and salts thereof, polyacrylic acid and salts thereof, iminodiacetic acid and salts thereof, and citric acid and salts thereof.

The content of the compound in the metal alloy material polishing composition is preferably 0.01% by mass or more, and more preferably 0.1% by mass or more. As this content increases, the surface roughening and the defects on a polished surface of the metal alloy material are further suppressed.

The content of the compound in the metal alloy material polishing composition is preferably 10% by mass or less, and more preferably 5% by mass or less. As this content decreases, the polishing rate of the metal alloy material is enhanced.

The metal alloy material polishing composition may contain abrasive grains. The abrasive grains function to mechanically polish the surface of the metal alloy material, thereby enhancing the polishing rate of the metal alloy material.

Examples of the abrasive grains include silicon oxide, aluminum oxide, cerium oxide, zirconium oxide, titanium oxide, manganese oxide, silicon carbide, and silicon nitride. The abrasive grains may be used singly or in combination of two or more kinds.

Among others, silicon oxide or aluminum oxide is preferred as the abrasive grains, silicon oxide is more preferred, colloidal silica or fumed silica is still more preferred, and colloidal silica is particularly preferred. By using these materials, a smoother and more satisfactory polished surface is easily obtained.

When the metal alloy material polishing composition contains abrasive grains, it is preferred that the compound having a functional group bonded to carbon and capable of trapping the second metal species be immobilized on the abrasive grains. In this case, the dispersibility of the abrasive grains is enhanced. Immobilization of the above-described compound on the abrasive grains is performed by chemically bonding the compound to the surfaces of the abrasive grains.

Then, a method for immobilizing the above-described compound on colloidal silica is described as an example. When a compound having a sulfo group is immobilized on colloidal silica, the immobilization can be performed, for example, by the method described in “Sulfonic acid-functionalized silica through quantitative oxidation of thiol groups”, Chem. Commun. 246-247 (2003). Specifically, colloidal silica on which surface a compound having a sulfo group is immobilized can be obtained by coupling a silane coupling agent having a thiol group, such as 3-mercaptopropyl trimethoxysilane, to colloidal silica, followed by oxidizing the thiol group with hydrogen peroxide. When a compound having a carboxyl group is immobilized on colloidal silica, the immobilization can be performed, for example, by the method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, colloidal silica on which surface a compound having a carboxyl group is immobilized can be obtained by coupling a silane coupling agent containing a photoreactive 2-nitrobenzyl ester to colloidal silica, followed by photoirradiation.

The pH of the metal alloy material polishing composition is preferably 7.0 or more. In this case, since the stability of the abrasive grains in the metal alloy material polishing composition is improved, a satisfactory polished surface is easily obtained.

The mean primary particle size of the abrasive grains contained in the metal alloy material polishing composition is preferably 5 nm or more, more preferably 10 nm or more, and still more preferably 15 nm or more. As the mean primary particle size of the abrasive grains increases, the polishing rate of the metal alloy material is enhanced.

The mean primary particle size of the abrasive grains contained in the metal alloy material polishing composition is preferably 400 nm or less, more preferably 300 nm or less, and still more preferably 200 nm or less. As the mean primary particle size of the abrasive grains decreases, a surface with less surface roughening, fewer defects, and low roughness is easily obtained.

The mean primary particle size of the abrasive grains can be calculated from the measured values of the specific surface area thereof by the nitrogen adsorption method (BET method).

The content of the abrasive grains in the metal alloy material polishing composition is preferably 1% by mass or more, and more preferably 2% by mass or more. As the content of the abrasive grains increases, the polishing rate of the metal alloy material is enhanced.

The content of the abrasive grains in the metal alloy material polishing composition is preferably 50% by mass or less, and more preferably 40% by mass or less. As the content of the abrasive grains decreases, the production cost of the metal alloy material polishing composition is reduced and additionally, a polished surface with fewer scratches is easily obtained. Moreover, as the content of the abrasive grains decreases, the amount of the abrasive grains remaining on a polished surface of the metal alloy material is reduced, thereby making washing the metal alloy material after polishing easier.

Next, a metal alloy material production method for producing a polished metal alloy material will be described.

The metal alloy material production method includes a step of polishing a metal alloy material using the metal alloy material polishing composition. The metal alloy material polishing composition can be used in the same equipment and under the same condition as those commonly used in polishing a metal material. When a polishing pad is used, the metal alloy material is mechanically polished by a friction between the polishing pad and the metal alloy material and a friction between the metal alloy material polishing composition and the metal alloy material.

Examples of the polishing equipment include single-side polishing equipment and double-side polishing equipment. In the single-side polishing equipment, the metal alloy material is held using a holding tool called a carrier. A platen on which a polishing pad has been attached is pressed against the single surface of the metal alloy material and the platen is rotated, while the metal alloy material polishing composition being supplied. In this manner, the single surface of the metal alloy material is polished. In the double-side polishing equipment, the metal alloy material is held using a carrier. Platens on which polishing pads have been attached, respectively, are pressed against the both surfaces of the metal alloy material and the platens are rotated, while the metal alloy material polishing composition being supplied from the above. In this manner, the both surfaces of the metal alloy material are polished.

The polishing conditions include a polishing load and a polishing linear velocity. Typically, as the polishing load increases, the mechanical processing characteristics are improved, thereby enhancing the polishing rate. In addition, typically, as the polishing load decreases, the surface roughening on a polished surface is suppressed. The polishing load applied during polishing using the metal alloy material polishing composition is preferably 20 to 1,000 g/cm², and more preferably 50 to 500 g/cm², for example.

The polishing linear velocity is typically affected by the rotational frequency of the polishing pad, the rotational frequency of the carrier, the size of the metal alloy material, the number of the metal alloy material, and the like. When the linear velocity is high, the friction force applied to the metal alloy material increases, thereby mechanically polishing the metal alloy material more easily. The polishing linear velocity is preferably 10 to 300 m/min, and more preferably 30 to 200 m/min, for example. When the linear velocity is in the range described above, a sufficiently high polishing rate is obtained, and additionally, the proper friction force is applied to the metal alloy material.

The polishing pad is not particularly limited and any of, for example, those of nonwoven cloth type, suede type, and those containing abrasive grains or not containing abrasive grains may be used.

Next, with respect to the metal alloy material polishing composition and the method for producing a metal alloy material using the same, action thereof will be described.

When a metal alloy material is polished using the metal alloy material polishing composition, the metal species in the metal alloy material are eluted into the metal alloy material polishing composition. Among the eluted metal species, the second metal species, which has a standard electrode potential higher than that of the first metal species, is likely to be precipitated. There is a possibility that the precipitation of the second metal species forms fine damage on a polished surface of the metal alloy material. In addition, there is also a possibility that the precipitate itself forms defects on the polish surface or causes surface roughening. In that respect, the metal alloy material polishing composition according to the present embodiment suppresses the precipitation of the second metal species due to inclusion of the compound having a functional group bonded to carbon and capable of trapping the second metal species, thereby reducing the adverse effects to a polished surface of the metal alloy material associated with the precipitation of the second metal species.

According to the present embodiment described above in detail, the following effects are exhibited:

(1) The metal alloy material polishing composition contains a compound capable of trapping the second metal species, i.e., the metal that is other than the main component in the metal alloy material and has a standard electrode potential higher than that of the main component metal. This suppresses the surface roughening and the defects on a polished surface of the metal alloy material.

(2) The metal alloy material polishing composition may further contain abrasive grains, and in this case, the above-described compound is preferably immobilized on the abrasive grains. This increases the dispersibility of the abrasive grains.

(3) When the metal alloy material is mainly composed of any one of magnesium, aluminum, titanium, chromium, and iron, a lot of the metal species having standard electrode potentials higher than that of the main component metal are contained in the metal alloy material, thereby easily causing generation of the surface roughening and the defects on a polished surface due to the precipitation of those metal species. Accordingly, it is particularly effective to use the metal alloy material polishing composition according to the present embodiment for polishing such a metal alloy material, or further, a metal alloy material composed mainly of aluminum and containing at least one metal element selected from iron, copper, and zinc in an amount of 1.0% by mass or more.

The embodiment described above may be modified as follows:
The metal alloy material polishing composition may further contain a compound capable of trapping the second metal species apart from the compound having a functional group bonded to carbon and capable of trapping the second metal species. Examples of such a compound include water-soluble polymers, such as polycarboxylic acids, polyphosphonic acids, polysaccharides, cellulose derivatives, ethylene oxide polymers, and vinyl polymers, water-soluble copolymers, and salts and derivatives thereof. These compounds are used also for the purpose of imparting hydrophilicity to the surface of the metal alloy material or enhancing the dispersibility of the ingredients in the composition.
The metal alloy material polishing composition may further contain additives such as a dispersant for enhancing the dispersibility of the abrasive grains and a dispersing auxiliary for increasing the re-dispersibility of aggregates of the abrasive grains, as needed. In addition, the metal alloy material polishing composition may further contain an antiseptic agent, an antifungal agent, or an antirust agent, as needed.
The metal alloy material polishing composition may be of either a one-pack type or a multi-pack type composed of two or more packs.
Each ingredient contained in the metal alloy material polishing composition may be filtered through a filter immediately before the production. The metal alloy material polishing composition may be filtered through a filter immediately before the use. The filtration removes large impurities in the metal alloy material polishing composition to improve the quality.

The material and structure of the filter used for the filtration described above are not particularly limited. Examples of the filter material include cellulose, nylon, polysulfone, polyethersulfone, polypropylene, polytetrafluoroethylene (PTFE), polycarbonate, and glass. Any type of filter of a depth filter, a pleated filter, and a membrane filter may be used.
The metal alloy material polishing composition having been used to polish a metal alloy material may be collected and reused (recycled). More specifically, the used metal alloy material polishing composition having been discharged from the polishing equipment may be collected in a tank, and then again supplied to the polishing equipment from the tank. This reduces the need for disposing the used polishing composition as a waste and therefore reduces the impact on the environment. In addition, if the amount of use of the metal alloy material polishing composition is reduced, the cost for polishing the metal alloy material is also reduced.

When the metal alloy material polishing composition is recycled, it is preferred to replenish at least any of the ingredients in the metal alloy material polishing composition having been reduced in the amount through consumption or loss during the use in polishing the metal alloy material. The ingredients to be replenished may be individually added to the used metal alloy material polishing composition, or alternatively, added in the form of a mixture containing two or more ingredients at any concentrations to the used metal alloy material polishing composition.
The metal alloy material polishing composition may be prepared by diluting an undiluted solution of the metal alloy material polishing composition with water.
A preliminary polishing step may be carried out prior to the polishing of the metal alloy material using the metal alloy material polishing composition. A finishing-polishing step may be carried out after the polishing of the metal alloy material using the metal alloy material polishing composition.

### EXAMPLES

Next, the present invention will be described in more detail with reference to examples and comparative examples.

As shown in Table 1, metal alloy material polishing compositions of Examples 1 and 2 and Comparative Examples 1 and 2 were prepared by diluting abrasive grains with water. Metal alloy material polishing compositions of Examples 3 to 6 and Comparative Example 3 were prepared by further adding specific compounds.

“Silica A (surface-modified)” described in the column “Type” in the column “Abrasive grain” of Table 1 represents colloidal silica on which a compound having a sulfo group is immobilized and “Silica B (untreated)” in the same column represents colloidal silica without surface-modification. In the column “Primary particle size” in the column “Abrasive grains” of Table 1, the mean primary particle sizes of the abrasive grains in the respective metal alloy material polishing compositions are shown. In the column “Content” in the column “Abrasive grain” of Table 1, the contents of the abrasive grains in the respective metal alloy material polishing compositions are shown. In the column “Compound” of Table 1, the types and the contents of the specific compounds in the respective metal alloy material polishing compositions are shown. In the column “pH” of Table 1, the pHs of the respective metal alloy material polishing compositions are shown.

As a metal alloy material, the aluminum alloy having the following composition was provided:

Si 0.11%

Fe 0.22%, standard electrode potential of Fe: −0.440 V

Cu 0.9%, standard electrode potential of Cu: +0.340 V

Mn 0.27%, standard electrode potential of Mn: −1.180 V

Mg 3.3%, standard electrode potential of Mg: −2.356 V

Zn 4.8%, standard electrode potential of Zn: −0.763 V

Cr 0.13%, standard electrode potential of Cr: −0.740 V

Ti 0.08%, standard electrode potential of Ti: −1.630 V

Al≧90% (balance), standard electrode potential of Al: −1.676 V

“Iminodiacetic acid”, “citric acid”, and “polystyrenesulfonic acid” described in the column “Compound” of Table 1 have an ability to trap at least Cu in the aluminum alloy described above and the “phosphoric acid-based surfactant” does not have an ability to trap the metal species contained in the aluminum alloy.

The aluminum alloy was polished using each of the metal alloy material polishing compositions of Examples 1 to 6 and Comparative Examples 1 to 3 under the conditions described in Table 2. Then, the polishing rate of the aluminum alloy was determined and the surface roughness of the metal alloy material after polishing was measured, for each metal alloy material polishing composition.

### <Calculation of Polishing Rate>

Each polishing rate was calculated from the weight difference of the metal alloy material between before and after polishing. The results are shown in the column “Polishing rate” of Table 1.

### <Determination of Surface Roughness>

The surface roughness Ra of each metal alloy material after polishing was determined using a surface shape measuring instrument (product name: Zygo New View 5000 5032, manufactured by Zygo Corporation). The surface roughness Ra is a parameter indicating the mean amplitude in the height direction of the roughness curve, indicating the arithmetical mean of the height of the metal alloy material surface in a certain visual field. The measurement region by the surface roughness shape measuring instrument was 1.4 mm×1.1 mm. The results are shown in the column “Surface roughness Ra” of Table 1.

TABLE 1

| | Abrasive grains | | | Compound | | | Polishing | Surface |
|---|---|---|---|---|---|---|---|---|
| | | Primary particle | Content | | Content | | rate | roughness |
| | Type | size [nm] | [% by mass] | Type | [% by mass] | pH | [μm/min] | Ra [μm] |
| Example 1 | Silica A | 35 | 20 | — | — | 10.0 | 0.083 | 3.4 |
| | (surface- | | | | | | | |
| | modified) | | | | | | | |
| Example 2 | Silica A | 35 | 5 | — | — | 10.0 | 0.091 | 5.1 |
| | (surface- | | | | | | | |
| | modified) | | | | | | | |
| | Silica B | 50 | 12 | | | | | |
| | (untreated) | | | | | | | |
| Example 3 | Silica B | 50 | 20 | Iminodiacetic | 1.0 | 2.5 | 0.111 | 4.9 |
| | (untreated) | | | acid | | | | |
| Example 4 | Silica B | 50 | 20 | Citric acid | 1.0 | 2.5 | 0.102 | 6.5 |
| | (untreated) | | | | | | | |
| Example 5 | Alumina | 300 | 5 | Citric acid | 1.0 | 2.5 | 0.079 | 7.0 |
| Example 6 | Silica B | 50 | 20 | Polystyrenesulfonic | 5.0 | 2.5 | 0.074 | 6.0 |
| | (untreated) | | | acid | | | | |
| Comparative | Silica B | 80 | 20 | — | — | 10.0 | 0.261 | 27.2 |
| Example 1 | (untreated) | | | | | | | |
| Comparative | Silica B | 50 | 20 | — | — | 10.0 | 0.110 | 11.2 |
| Example 2 | (untreated) | | | | | | | |
| Comparative | Silica B | 50 | 20 | Phosphoric acid- | 0.1 | 9.6 | 0.067 | 25.9 |
| Example 3 | (untreated) | | | based surfactant | | | | |

TABLE 2
Polishing conditions

| | |
|---|---|
| Polishing machine: | Single surface polishing machine “EJ-3801N”, |
| | manufactured by Engis Japan |
| | Corporation (platen diameter: 380 mm) |
| Polishing pad: | Suede pad |
| Polishing load: | 100 g/cm² |
| Platen rotational | 50 rpm |
| frequency: | |
| Linear velocity: | 64 m/minute |
| Polishing time: | 10 minutes |
| Supply rate of polishing | 20 ml/minute (used without recycling) |
| composition: | |

As shown in Table 1, the values of the surface roughness Ra in Examples 1 to 6 were smaller than those in Comparative Examples 1 to 3. From these results, it is found that use of the metal alloy material polishing compositions of Examples 1 to 6 results in successfully obtaining a metal alloy material having a polished surface with a smaller surface roughness Ra, that is, a metal alloy material having less surface roughening and suppressed defects on a polish surface.

1. A metal alloy material polishing composition used for polishing a metal alloy material, wherein the metal alloy material contains a first metal species as a main component and a second metal species that is of a different kind from the first metal species, the second metal species having a standard electrode potential higher than that of the first metal species,
the metal alloy material polishing composition comprising a compound having a functional group bonded to carbon and capable of trapping the second metal species.

2. The metal alloy material polishing composition according to claim 1, further comprising abrasive grains, wherein the compound is immobilized on the abrasive grains.

3. The metal alloy material polishing composition according to claim 1, wherein the main component of the metal alloy material is any one of magnesium, aluminum, titanium, chromium, and iron.

4. The metal alloy material polishing composition according to claim 1, wherein
the main component of the metal alloy material is aluminum, and
the metal alloy material contains at least one metal element selected from the group consisting of iron, copper, and zinc in an amount of 1.0% by mass or more.

5. A method for producing a polished metal alloy material, comprising
providing a metal alloy material; and
using the metal alloy material polishing composition according to claim 1 to polish the metal alloy material.
